(19) United States
(12) Patent Application Publication
(10) Pub. No.: US 2015/0036458 A1
(43) Pub. Date: Feb. 5, 2015

(54) MIXER HOUSEHOLD APPLIANCE

(71) Applicant: Henrik Holm, Stockholm (SE)

(72) Inventor: Henrik Holm, Stockholm (SE)

(73) Assignee: Aktiebolaget Electrolux, Stockholm (SE)

(21) Appl. No.: 14/378,776

(22) PCT Filed: Feb. 15, 2012
(86) PCT No.: PCT/EP2012/052598

§ 371 Date: Sep. 8, 2014

(51) Int. Cl. A47J 43/046

(52) U.S. Cl. CPC A47J 43/046
USPC 366/205

(57) ABSTRACT

A mixer household appliance having a container unit and a base unit. The container unit includes a container for foodstuff and a rotor element arranged inside the container at a first end of the container unit. The appliance further includes a lid for at least partially covering an opening of the container unit. A device extends into the container via the lid and includes a surface element. The device is arranged to be fixedly positioned in at least a first position and a second position. In the first position of the device, the surface element is arranged at a first distance from the rotor element. In the second position of the device the surface element is arranged at a second distance from the rotor element.

### TECHNICAL FIELD

The present invention relates to a mixer household appliance generally used for mixing, blending, and/or cutting foodstuff.

### BACKGROUND

A mixer household appliance for mixing, blending, and/or cutting foodstuff commonly comprises two units, a base unit comprising an electric motor and forming a support for the appliance, and a container unit comprising a container for the foodstuff and a rotor element arranged in the container. The container unit is provided with a lid covering an opening of the container. Such an appliance may be referred to under different names such as inter alia mixer, food mixer, blender, or food blender. The rotor element is rotated by means of the electric motor. The base unit and the container unit are separable from each other and a separable coupling arrangement is provided between the electric motor and the rotor element.

During operation noise is emitted from a mixer appliance. Noise emanates from various parts and positions of the mixer appliance, e.g. the electric motor, the separable connection, the rotor element, and foodstuff being mixed or cut by the rotor element.

Various solutions have been proposed to reduce the noise level emitted from a mixer. For instance, each of US 2005/152215 and US 2003/034200 proposes an enclosure enclosing the container unit of a blender.

JP 40730232 A discloses a vessel for a food mixer, with improved thermal and sound insulating properties. A vessel main-body comprises an external wall layer and an internal wall layer with an air layer therebetween.

WO 2006/092500 relates to a blender-type electrical cooking appliance comprising a container, the base of which is equipped with an operating tool which is rotated by a motor. The container is closed by a cover which is provided with an opening that can be used to insert a stirrer such that a lower concave deflector of the stirrer is disposed close to the operating tool. Positioned close to the operating tool, the concave deflector pushes foodstuff towards the operating tool. Alternatively, the stirrer may be used as a scraper for pushing food stuff from a top to a base of the container.

A further reduction of noise emitted from a mixer household appliance and/or alternative ways of reducing noise emitted from a mixer household appliance are desirable.

### SUMMARY

An object of the present invention is to provide a mixer household appliance with a low noise level.

According to an aspect of the invention, the object is achieved by a mixer household appliance comprising a container unit and a base unit. The base unit comprises a housing and an electric motor. The container unit comprises a container for foodstuff and a rotor element arranged inside the container at a first end of the container unit. The electric motor is arranged to rotate the rotor element about an axis. The appliance further comprises a lid for at least partially covering an opening at a second end of the container unit and a device. The device extends into the container via the lid and comprises a surface element extending in a direction substantially perpendicularly to the axis. The device is arranged to be fixedly positioned in at least a first position and a second position. In the first position of the device the surface element is arranged at a first distance from the rotor element inside the container. In the second position of the device the surface element is arranged at a second distance from the rotor element inside the container.

It has been realized by the inventor that noise emanating from the rotor element during mixing, blending, or cutting foodstuff is transmitted via a cone of air inside a vortex formed in the foodstuff being rotated by the rotor element. Further, it has been discovered by the inventor that closing off at least part of the vortex reduces noise emitted from the rotor element to an ambient environment of the appliance.

Since the device comprises a surface element, which is arranged to be positioned in at least two different positions inside the container, the surface element is able to be positioned to cover a lower part of a vortex to reduce noise transmitted via the cone of air of the vortex. The size of the vortex may vary depending on amount and type of foodstuff being mixed, blended, and/or cut. Accordingly, an adjustable repositionable device comprising a surface element is required to achieve noise reduction under at least some different operating conditions. As a result, the above mentioned object is achieved.

It is remarked with respect to WO 2006/092500 that the concave deflector does not close off any vortex formed in the appliance since the concave deflector is arranged to push foodstuff towards the operating tool. This can only be achieved if the concave deflector is positioned within the foodstuff, i.e. below any vortex formed.

The base unit may form a support of the appliance, which base unit is placed upon a supporting surface during use of the appliance. The rotor element may form part of a rotor arranged in the container unit. The rotor element may comprise a cutting element. The container unit may be removable form the base unit. A coupling arrangement may be provided between the electric motor and the rotor element to form a separable connection between the electric motor and the rotor element. The container unit may comprise a sleeve at its first end. A free end of the sleeve may form a bottom surface, upon which the container unit may stand when the container unit is not connected to the base unit. The coupling arrangement may form a direct connection between the rotor and the motor, i.e. the rotor may be directly driven by the electric motor. A transmission may be arranged between the electric motor and the rotor.

During use of the mixer appliance, a vortex may form in the foodstuff being mixed, blended, and/or cut by means of the rotor element rotating inside the container, if the foodstuff has a sufficiently liquid consistency. A user may position the device of the appliance in one of the first and second positions to cover the vortex or a lower portion of the vortex. That is, the surface element is positioned to close off the vortex or the lower portion of the vortex by an edge portion of the surface element touching the foodstuff above the vortex or from within the rotating cone-shaped vortex.

According to embodiments, in the first position and in the second position of the device the surface element may be arranged along the axis. In this manner the surface element may easily be centred within a vortex formed in the container.

According to embodiments, the device may comprise a shaft and the lid may comprise a through hole. The shaft may extend through the through hole. The shaft may be movably arranged in the through hole. In this manner the shaft may be positioned in the first position and the second position in the through hole.

According to embodiments, the shaft may be arranged with a press fit in the through hole. In this manner the device may be fixedly positioned in the first position and the second position in the through hole by means of the press fit between the shaft and the through hole.

According to embodiments, the shaft may be foldable. In this manner the shaft may be folded to reduce the height of the appliance during storing.

According to embodiments, the surface element may be substantially circular with a larger diameter than an extent of a cross section of the shaft perpendicularly to the axis.

According to embodiments, a position of the device may be continuously adjustable along the axis. This may for instance be achieved by means of the shaft being press fit in the through hole over at least a portion of shaft. The position of the device may be continuously adjustable along at least a portion of the shaft.

According to embodiments, the device, in a motion position is movable to shift the surface element from the axis towards a wall portion of the container. In this manner the device may be further used as a scraper in the container.

According to embodiments, the surface element may comprise a convex surface facing the rotor element. In this manner the surface element may be suitably shaped for touching foodstuff from within a rotating vortex.

According to embodiments, the device may comprise a handle at an end opposite to the surface element. In this manner the device may be easily positioned in a desired position by a user.

According to embodiments, the container unit may be removably connected to the base unit and a coupling arrangement may form a separable connection between the electric motor and the rotor element.

Further features of, and advantages with, the present invention will become apparent when studying the appended claims and the following detailed description. Those skilled in the art will realize that different features of the present invention may be combined to create embodiments other than those described in the following, without departing from the scope of the present invention, as defined by the appended claims.

### BRIEF DESCRIPTION OF THE DRAWINGS

The various aspects of the invention, including its particular features and advantages, will be readily understood from the following detailed description and the accompanying drawings, in which:

FIG. 1 illustrates a mixer household appliance according to embodiments,

FIGS. 2a, 2b, 3, 4a, and 4b illustrate cross sections of a container units of a mixer according to embodiments.

### DETAILED DESCRIPTION

The present invention will now be described more fully with reference to the accompanying drawings, in which example embodiments are shown. However, this invention should not be construed as limited to the embodiments set forth herein. Disclosed features of example embodiments may be combined as readily understood by one of ordinary skill in the art to which this invention belongs. Like numbers refer to like elements throughout.

Well-known functions or constructions will not necessarily be described in detail for brevity and/or clarity.

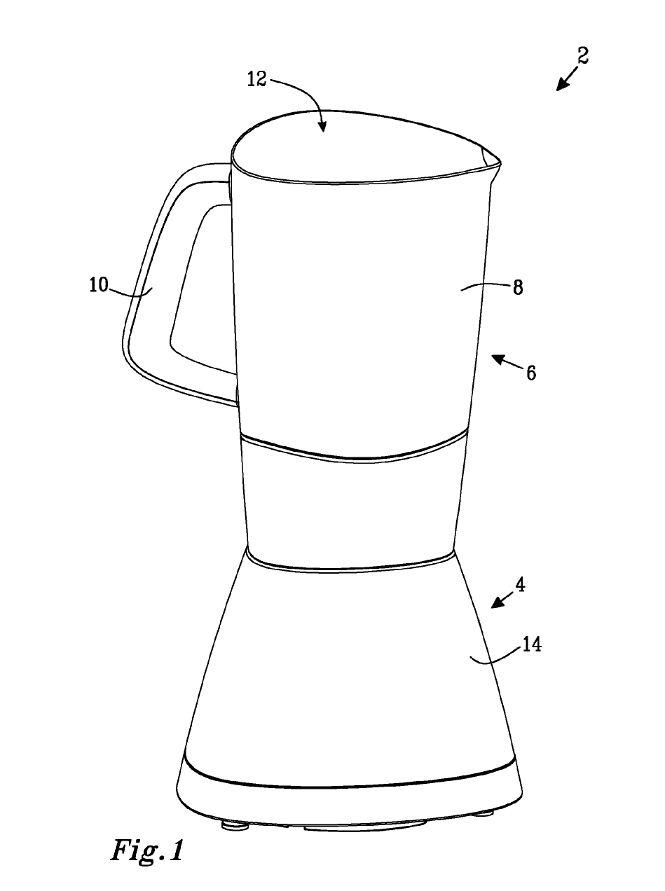

FIG. 1 illustrates a mixer household appliance 2, in the following called mixer 2, according to embodiments. The mixer 2 comprises a base unit 4 and a container unit 6. The container unit 6 comprises a container 8 in which foodstuff is placed, e.g. to be mixed, cut, and/or blended. The container unit 6 is releasably connected to the base unit 4. A handle 10 is provided on the container unit 6. A lid (not shown) may be placed on the container unit 6 to cover an opening 12 of the container 8 to hold foodstuff inside the container 8, e.g. during mixing. The base unit 4 forms a support for the mixer 2. The base unit 4 may be placed on a supporting surface during operation of the mixer 2. The base unit 4 comprises a housing 14, inside which an electric motor is arranged. The electric motor is arranged to drive a rotor element arranged inside the container unit 6.

The base unit 4 may further comprise a switch (not shown) for controlling the electric motor and a power cord (not shown) for connecting the electric motor to an electric wall socket.

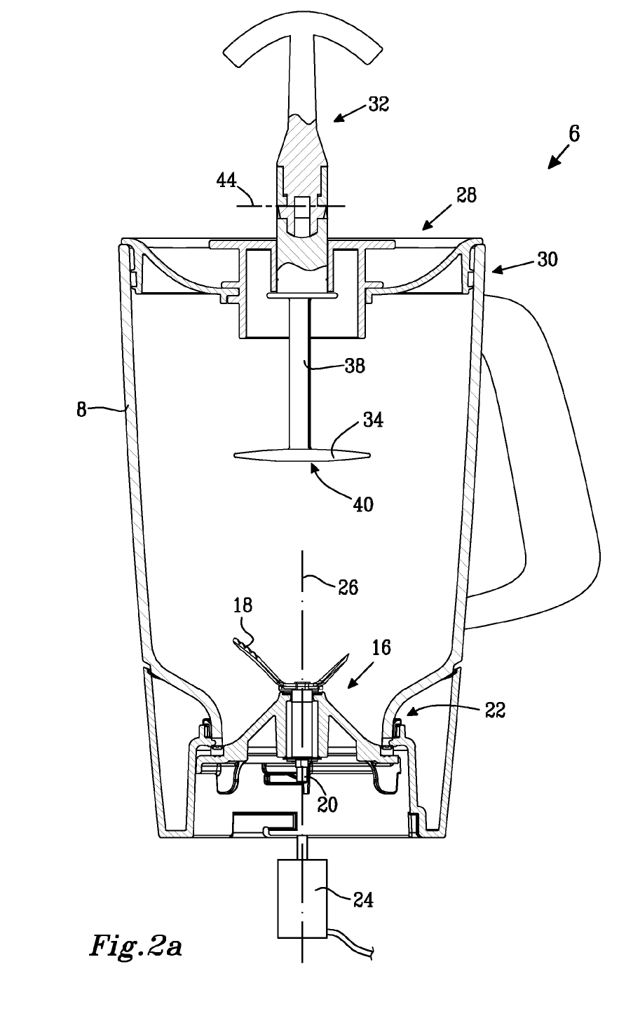

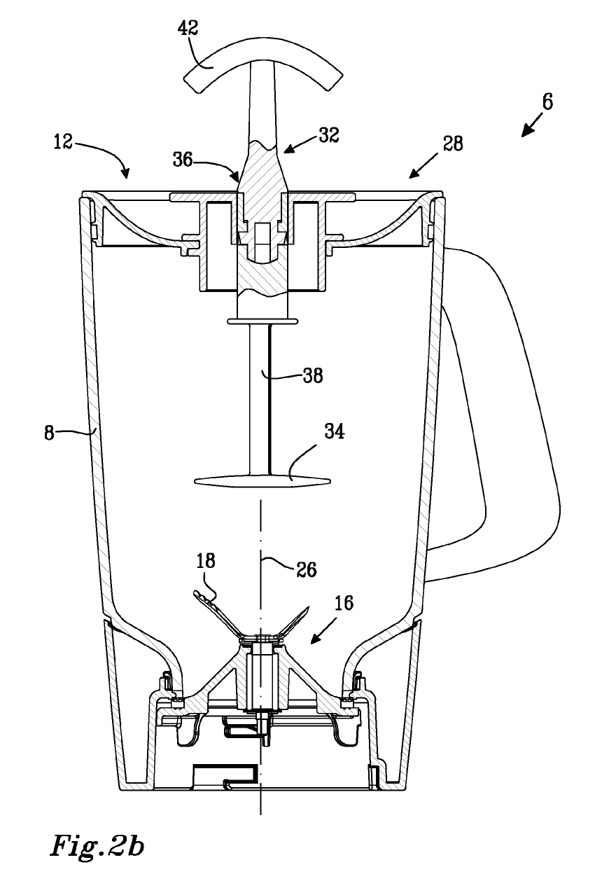

FIGS. 2a and 2b illustrate cross sections of a container unit 6 of a mixer according to embodiments. The container unit 6 comprises a container 8 in which foodstuff may be placed. A rotor 16 comprises a rotor element 18 and a rotor axle 20. The rotor element 18 is arranged inside the container 8 at a first end 22 of the container unit 6. An electric motor 24 of a base unit (not shown) is arranged to rotate the rotor 16 and the rotor element 18 about an axis 26.

A lid 28 covers an opening 12 at a second end 30 of the container unit 6. The lid 24 is removable form the container unit 6. A device 32 extends into the container 8 via the lid 24 and comprises a surface element 34 extending in a direction substantially perpendicularly to the axis 26. The device 32 is arranged to be fixedly positioned in at least a first position and a second position in a through hole 36 of the lid 28. In the first position of the device 32, the surface element 34 is arranged at a first distance from the rotor element 18 inside the container 8. The first position of the device 32 is illustrated in FIG. 2a. In the second position of the device 32, the surface element 34 is arranged at a second distance from the rotor element 18 inside the container 8. The second position of the device 32 is illustrated in FIG. 2b. In the first position and in the second position of the device 32 the surface element 34 is arranged along the axis 26.

The device 32 comprises a shaft 38 extending through the through hole 36 of the lid 28. The shaft 38 movably arranged in the through hole 36. The surface element 34 is substantially circular with a lager diameter than an extent of a cross section of the shaft 38 perpendicularly to the axis 26. In short, the shaft 38 has a smaller diameter than the surface element 34. The surface element 34 comprises a convex surface 40 facing the rotor element 18. The device 32 comprises a handle 42 at an end opposite to the surface element 34. A user may thus grab the handle 42 to adjust a position of the device 32 in the container 8.

Along a portion of the shaft 38, it is arranged with a press fit in the through hole 36. Thus, the device 32 may be positioned in the first and the second positions. Furthermore, a position of the device 32 is continuously adjustable at least along the portion of the shaft 38. A position of the device 32 may be continuously adjustable along the axis 26. The shaft 38 of the device 32 is foldable along a folding axis 44. During storing of the container unit 6 in an assembled state, the height of the container unit 6, may thus be reduced by folding the shaft 38 about the folding axis 44.

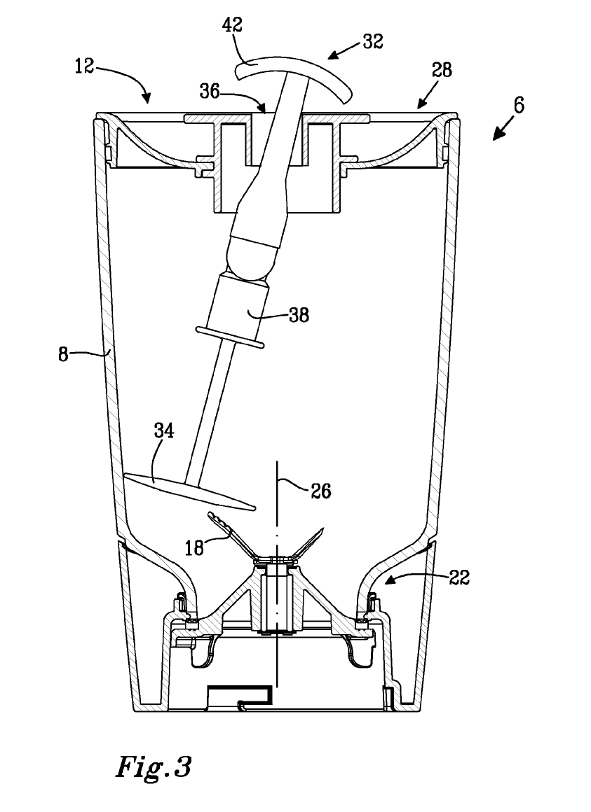

FIG. 3 illustrates a cross section of a container unit 6 of a mixer according to embodiments. The container unit 6 comprises a container 8 in which foodstuff may be placed. A rotor element 18 is arranged to be rotated about an axis 26 inside the container 8 at a first end 22 of the container unit 6. A lid 28 covering an opening 12 of the container 8, comprises a through hole 36. A device 32 extends into the container 8 via the through hole 36 and comprises a surface element 34. The device 32 is arranged to be fixedly positioned in at least a first position and a second position along the axis 26 in the through hole 36.

The device 32 comprises a shaft 38. The shaft 38 has a narrow portion at an end opposite to the surface element 34. This narrow portion has a smaller diameter than the through hole 36. Thus, when the device 32 is positioned in the through hole 36 such that the narrow portion is arranged within the though hole 36, as illustrated in FIG. 3, the device is in a motion position. In the motion position the device 32 is movable to shift the surface element 34 from the axis 26 towards a wall portion of the container 8. In this manner the device 32 may be used as a scraper, e.g. to push foodstuff towards the first end 22 of the container unit 6. A handle 42 of the device 32 arranged to abut against the lid 28 when the device 32 is fully pushed into the container 8 may prevent the surface element 34 from reaching the rotor element 18.

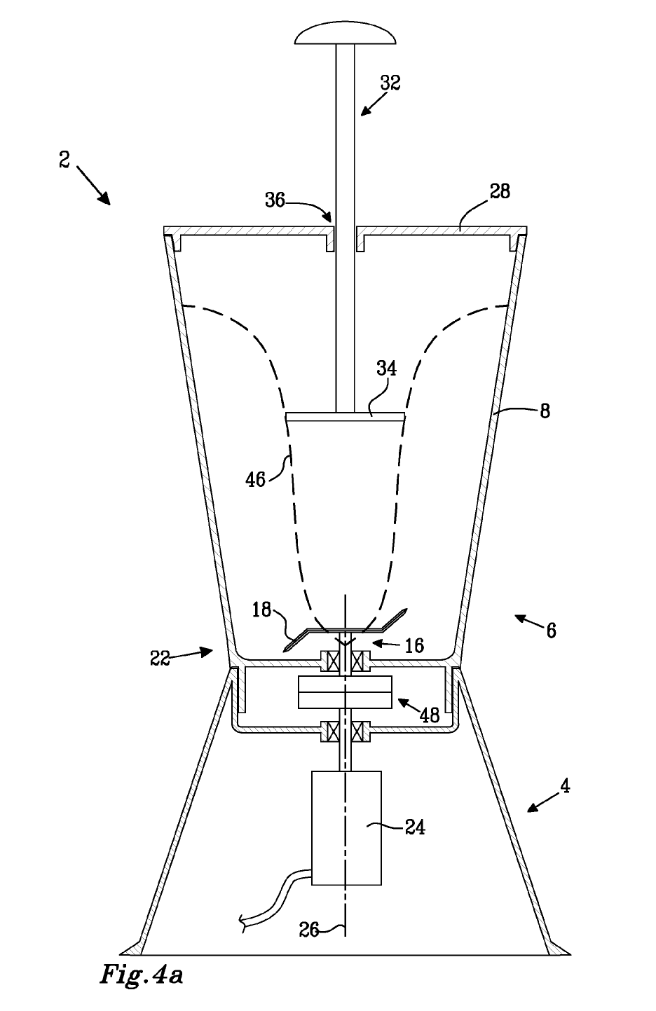

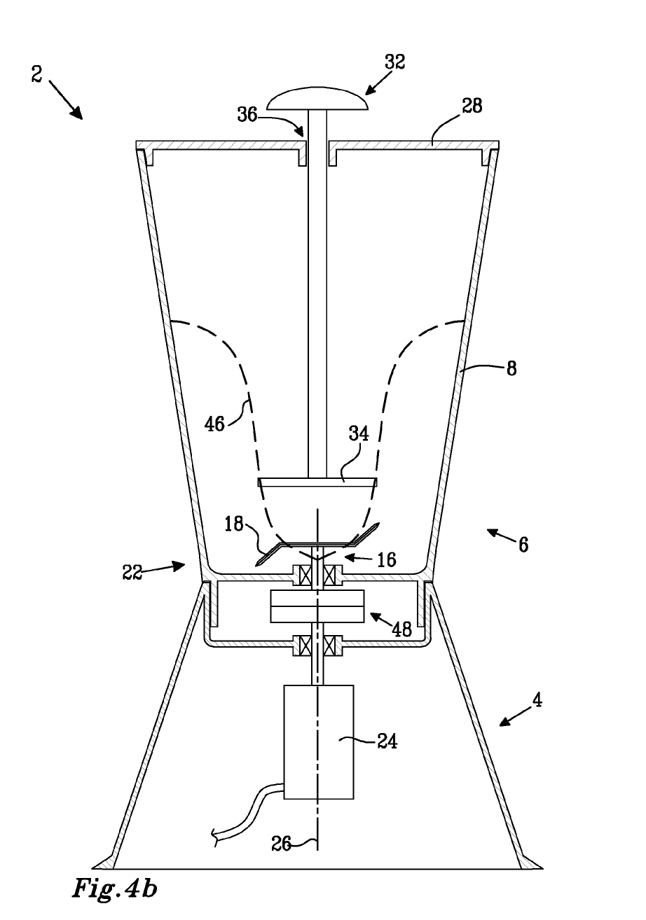

FIGS. 4a and 4b illustrate cross sections of a mixer 2 according to embodiments. The mixer 2 comprises a base unit 4 and a container unit 6. The container unit 6 comprises a container 8 in which foodstuff may be placed. The container unit 6 further comprises a rotor 16, which rotor 16 comprises a rotor element 18. The rotor element 18 is arranged inside the container 8 at a first end 22 of the container unit 6. The base unit 4 comprises an electric motor 24 arranged to rotate the rotor 16 about an axis 26.

A device 32 extends into the container 8 via a lid 28 of he container unit 8. The device 32 comprises a surface element 34 extending in a direction substantially perpendicularly to the axis 26. The device 32 is arranged to be fixedly positioned at different positions in a through hole 36 of the lid 28 such that the surface element 34 may be positioned at different distances from the rotor element 18. A position of the device 32 may be continuously adjustable along the axis 26 but at least the device 32 is able to be positioned with the surface element 34 in at least a first position and a second position. Thus, the surface element 34 may be positioned to close off a vortex 46 formed in foodstuff being rotated by the rotor element 18 inside the container 8. A user may position the device 32 such that an open connection from a bottom of the vortex 46 to a top of the vortex 46 is closed. In this manner noise emitted from the rotor element 18 is prevented from propagating through the cone of air formed inside the vortex 46 of foodstuff. Thus, the noise level from the mixer 2 may be reduced by about 2 dB in some operating situations compared to if the vortex would not be closed off.

In FIG. 4a the device 32 is illustrated in a first position, in which the surface element 34 is arranged at a first distance from the rotor element 18. In FIG. 4b the device 32 is illustrated in a second position, in which the surface element 34 is arranged at a second distance from the rotor element 18. In FIG. 4a the vortex 46 is formed in a larger amount of foodstuff than the vortex 46 formed in FIG. 4b. Accordingly, the first position of the device, in which the surface element 34 is at a greater distance from the rotor element 18 than in the second position, may be suitable when there is a large amount of foodstuff in the container 8 and the second position may be suitable when there is a medium or small amount of foodstuff inside the container 8.

The container unit 6 is removably connected to the base unit 4 and a coupling arrangement 48 forms a separable connection between the electric motor 24 and the rotor 16 with the rotor element 18.

Example embodiments described above may be combined as understood by a person skilled in the art. Although the invention has been described with reference to example embodiments, many different alterations, modifications and the like will become apparent for those skilled in the art. The lid 28 may for instance comprise one or more parts, which parts may be separable. The shaft 38 may have a round, oval, square, or any other suitable cross section. The through hole 36 may have a corresponding cross section. The device may be fixedly positioned in the first position and the second position and/or in further positions by other means than a press fit between the shaft of the device and the through hole of the lid. For instance, the shaft may be snap fit to the lid in the through hole in the different positions, the shaft may be fixed in a relevant position by means of one or more screws or pins, or the shaft may be fixed to the lid by means of a hook-and-loop fastening system (Velcro).

As used herein, the term “comprising” or “comprises” is open-ended, and includes one or more stated features, elements, steps, components or functions but does not preclude the presence or addition of one or more other features, elements, steps, components, functions or groups thereof.

1. A mixer household appliance comprising a container unit and a base unit, which base unit comprises a housing and an electric motor, and which container unit comprises a container for foodstuff and a rotor element arranged inside the container at a first end of the container unit, wherein the electric motor is arranged to rotate the rotor element about an axis, and wherein the appliance further comprises a lid for at least partially covering an opening at a second end of the container unit and a device, the device extending into the container via the lid and comprising a surface element extending in a direction substantially perpendicularly to the axis,
wherein the device is arranged to be fixedly positioned in at least a first position and a second position, wherein in the first position of the device the surface element is arranged at a first distance from the rotor element inside the container (8), and wherein in the second position of the device the surface element is arranged at a second distance from the rotor element inside the container.

2. The mixer household appliance according to claim 1, wherein in the first position and in the second position of the device, the surface element is arranged along the axis.

3. The mixer household appliance according to claim 1, wherein the device comprises a shaft and the lid comprises a through hole, which shaft extends through the through hole, and wherein the shaft is movably arranged in the through hole.

4. The mixer household appliance according to claim 3, wherein the shaft is arranged with a press fit in the through hole.

5. The mixer household appliance according to claim 3, wherein the shaft is foldable.

6. The mixer household appliance according to claim 1, wherein the surface element is substantially circular with a larger diameter than an extent of a cross section of the shaft perpendicularly to the axis.

7. The mixer household appliance according to claim 1, wherein a position of the device is continuously adjustable along the axis.

8. The mixer household appliance according to claim 1, wherein the device in a motion position is movable to shift the surface element from the axis towards a wall portion of the container.

9. The mixer household appliance according to claim 1, wherein the surface element comprises a convex surface facing the rotor element.

10. The mixer household appliance according to claim 1, wherein the device comprises a handle at an end opposite to the surface element.

11. The mixer household appliance according to claim 1, wherein the container unit is removably connected to the base unit and a coupling arrangement forms a separable connection between the electric motor and the rotor element.
